(19) United States
(12) Patent Application Publication
(10) Pub. No.: US 2016/0169581 A1
(43) Pub. Date: Jun. 16, 2016

(54) BIOMASS-PROCESSING DEVICE AND METHOD

(71) Applicant: KOTYK ENERGY AG, Linz (AT)

(72) Inventor: Michael KOTYK, Gams (CH)

(73) Assignee: KOTYK ENERGY AG, Linz (AT)

(21) Appl. No.: 14/907,315

(22) PCT Filed: Jul. 25, 2014
(86) PCT No.: PCT/EP2014/066086

§ 371 Date: Jan. 25, 2016

(30) Foreign Application Priority Data
Jul. 25, 2013 (DE) 10 2013 107 981.4
Jul. 25, 2013 (DE) 10 2013 107 983.0
Jul. 25, 2013 (DE) 10 2013 107 985.7

(51) Int. Cl. F26B 23/02; F26B 1/00; F26B 25/00; C10L 5/36; B29C 45/03; C10L 5/30; C10L 5/44; F01K 7/16; F01K 23/12; B29C 45/00; F26B 23/00; C10L 5/08

(52) U.S. Cl. CPC F26B 23/028; F26B 23/002; F26B 1/005; F26B 25/002; C10L 5/363; C10L 5/08; C10L 5/30; C10L 5/442; F01K 7/16; F01K 23/12; B29C 45/0005; B29C 45/03; F26B 2200/24; F26B 2200/02; C10L 2200/0469; C10L 2290/06; C10L 2290/08; C10L 2290/30; C10L 2290/28; C10L 2290/54; C10L 2290/60; C10L 2290/34; B29K 2105/12

(57) ABSTRACT

The invention relates to a device for producing energy from biomass, comprising a heat-producing apparatus for producing heat and a drying apparatus, and a method for producing energy from biomass, in particular from fibrous biomass, preferably from wood fibers, comprising the step of producing heat by burning biomass remainders reduced to small pieces, in particular wood dust. The present invention further relates to a device and a method for the material utilization of fibers from biomass, in particular wood.

The invention relates to a biomass processing device, in particular for wood from forest thinnings, having a conveyor apparatus and a drying apparatus, as well as a biomass processing method for wood from forest thinnings in particular.

Furthermore, the invention relates to a pelletizing device, in particular for producing pellets from biomass, having a drying apparatus for drying the biomass, in particular a fibrous biomass, and/or for chipping biomass, a press apparatus for pressing pellets and a cooling apparatus for cooling pellets as well as a method for producing pellets. This method has in particular the steps of drying the biomass, in particular the fibrous biomass, with the help of a drying apparatus, pressing the biomass to form pellets with the help of a press apparatus, and cooling the pellets with a cooling apparatus.

Furthermore, the present invention relates to a device and a method for utilizing the material of fibers from biomass in particular wood.

In addition, the invention relates to a device for generating energy from biomass using a heat recovery apparatus for generating heat and a drying apparatus as well as a method for generating energy from biomass in particular from fibrous biomass, preferably from wood fibers, with the step of generating heat by burning shredded biomass residues, in particular sawdust.

The aforementioned invention can be applied in a production plant for green power and/or pellets. The device presented above and the method described here relate to subunits of such a production plant.

Typical producers of pellets are the operators of planing mills and saw mills. They produce the required raw materials, for example, wood shavings and sawdust as the waste product of their usual commercial activity.

To produce pellets, the waste products from the saw mill, i.e., the sawdust and wood shavings, are dried and/or redried. This generally utilizes waste heat from existing heating power plants. During the drying process, the water content in the chips is reduced from approx. 50% to approx. 8% in the continuous flow principle. Furthermore, the chips are freed of impurities such as rocks or pieces of metal.

Following that, the wood chips go to the so-called hammer mill, where the chips are converted to a uniform size. Before the chips are sent to a ripening tank, they are provided with a fine film of water. In the ripening tank the chips absorb the film of water that has been applied. This should ensure the required pliability during the subsequent pressing operation.

In the pressing operation, chips are sent to a pelletizing plant and/or pellet press where the chips are pressed by a steel die by means of grinding wheels under high pressure. The heat released in the pressing operation, created due to friction on the die, releases the lignin in wood. Furthermore, so-called press additives, which are added to the ripening tank before the pressing operation, are activated by heat to bind the loose chips. These press additives function as a type of adhesive, so that the resulting pellets have dimensional stability.

A stripping blade at the outlet of the die cuts the required length for pellets from strands pressed from chips. The deciding factor for the diameter of the pellets is the diameter of the press channels in the die. Depending on the desired diameter, the die may be replaced and pellets with a different diameter can be produced. Then the pellets that are produced are cooled in a cooler and finally stored.

In another method from the state of the art, instead of the planing chips and sawdust, would from thinnings is used. This wood consists of tree trunks from which the branches have been removed, for example, or branches with a moist bark. The method for utilization of tree thinnings differs from the method described above only in that the moist bark of the wood from thinnings is separated before chipping the tree trunks or branches and then is incinerated while still moist. The debarked wood from thinnings is then reduced to a size suitable for drying, so that the chipped wood from thinnings can be processed to pellets by the same route as the chips described above.

The moist bark which is obtained as a waste product is incinerated—as described above—so that heat is generated by the incineration of moist bark. This heat is then used for drying the debarked and chipped wood from thinnings to reduce its water content. This heat cannot be utilized directly because the water content in the flue gas is too high. With these plants the moist hot flue gases must be converted into the heating medium water by means of a heat exchanger and converted back to air as a heating medium in another heat exchanger upstream from the process. However, heat exchangers are a type of equipment that requires a great deal of maintenance and thus also causes high costs.

However, the heating value of wood declines with an increase in its moisture content. The moisture content of wood is an indicator of the amount of water stored in it. The combustion temperature in burning moist wood is also below an optimal range. The greater the moisture content of wood (so-called wood moisture) in burning, the greater the amount of heat required for evaporation of the water stored in the wood. Consequently, the combustion planes are cooled and so-called incomplete combustion occurs. On the one hand this term refers to incomplete oxidation and on the other hand it refers to the reduction of organic compounds or of carbon monoxide (CO) to carbon or wood tar during which new compounds may be formed and emitted such as, for example, carbon monoxide, carbon black, hydrocarbons and fine ash dust. In addition, some gases that are stored in gas cannot be released because of the low combustion temperatures. The result is a poor efficiency. The aforementioned substances are discharged directly into the environment in the state of the art and thus results in pollution.

The object of the present invention is therefore to provide a device as well as a method with the help of which moisture in biomass comprising bark is reduced before burning to thus ensure a high combustion temperature to prevent pollution and to increase the efficiency in the combustion.

The term biomass as used here is understood below to refer to sawdust, planing chips, grinding dust, wood residues obtained from forest thinning and/or wood chips, i.e., chipped wood.

The forms of biomass described above, such as wood from forest thinnings, planing chips or wood chips include, for example, Miscanthus giganteus and all other rapidly growing plants and energy-producing woods or wood from deciduous or foliage-bearing trees such as ash, chestnut, birch, beech, etc. or softwood of coniferous trees such as the yew, spruce, fir, etc. Of course other plants that produce biomass (such as ivy, pyracantha, or blackberry bramble) or the like can also be subsumed under the heading of biomass. The designation biomass is preferably also used for residual forest wood, forest wood thinnings, coupling products and/or wood chips, which contain both wood and bark or tree bark. The other plants listed above may of course also have bark. The term “coupling product” is understood to refer to parts of the tree, for example, that are difficult to utilize or cannot be utilized at all. For example, “coupling product” refers to decaying or rotten trees, crooked trunks or tree tops (tips of trees).

The object defined above is achieved according to the invention by the features of the independent claims.

Further advantageous exemplary embodiments of the present invention are the subject matter of the dependent claims.

According to a first aspect of the invention it is provided that a biomass processing device will have a conveyor apparatus and a drying apparatus.

It is favorable here if a heat dissipation channel of the drying apparatus is connected to a heat supply channel of the conveyor apparatus to carry heat from the drying apparatus into the conveyor apparatus. In this way the heat which is used to dry the biomass and which occurs during the drying process within the drying apparatus can be forwarded to the conveyor apparatus and used there for predrying the biomass. Thus, it is possible to begin to dry the biomass even before it enters the drying apparatus. This leads to energy savings in the drying apparatus. Such a predrying acts mainly on the outside of the biomass. Thus, for example, biomass with bark can be processed so that the water content of the bark in particular is reduced so that in turn the heating value of the biomass is increased. Consequently, the combustion temperature can be increased in burning a biomass treated according to this invention because, due to the reduced moisture content in the biomass (so-called wood moisture), less heat is required for evaporation of the water stored in the biomass. Thus, the flames during combustion reach higher temperatures, and so-called complete combustion can be achieved, wherein the substances such as carbon monoxide (CO) or wood tar can be prevented. A high temperature is especially favorable when burning biomass, because the gases stored in the biomass are released only at higher temperatures and so it can thus burn almost without leaving a residue. It is therefore also possible to disburse the ash from the burned biomass in the forest, for example. In contrast with that, the ash generated when burning the moist bark is classified as hazardous waste, which must be disposed of at great expense.

As described above, heat is preferably carried from the drying apparatus into the conveyor apparatus. Heat as a process variable is then transferred across a system boundary when there are temperature differences between the two systems and/or the drying apparatus and the conveyor apparatus.

In the transfer of heat, because of the second law of thermodynamics, thermal energy is transferred from the system with a higher temperature in the direction of the system with a lower temperature. This is true as long as there is a temperature difference between the two thermally coupled systems, which are therefore not yet in thermal equilibrium.

To carry the heat from the drying apparatus to the conveyor apparatus it is preferable to use a fluid such as air as the carrier of the heat which absorbs the heat at a location of a higher temperature and releases it again at a different location at a lower temperature. It is also possible to use a different fluid such as water, oil or silicone instead of air.

It is thus also possible to carry heat with the help of air from the drying apparatus to the conveyor apparatus, for example, by connecting a heat dissipation channel to a heat supply channel. This connection is preferably implemented by means of a thermally insulated guide such as a pipe or a tube.

The heat here may be, for example, waste heat from the drying apparatus. It is also possible for the heat introduced into the drying apparatus to be carried further to the conveyor apparatus after the transfer, i.e., after elimination of the temperature difference between the biomass and the drying apparatus and the fluid, which functions as the heating medium. The heat can then be released and/or transferred to the biomass in the conveyor apparatus for predrying.

The conveyor apparatus is ideally arranged upstream from the drying apparatus. It is advantageous here if the conveyor apparatus conveys biomass in the direction of the drying apparatus. Thus, with the help of the conveyor apparatus, biomass for drying enters the drying apparatus. By connecting the conveyor apparatus to the drying apparatus and/or by connecting the heat dissipation channel of the drying apparatus to the heat supply channel of the conveyor apparatus, heat used for drying the biomass in the drying apparatus goes to the upstream conveyor apparatus. It is possible in this way to reduce the water content of the biomass with bark in advance before charging the drying apparatus. The use of energy for drying within the drying apparatus can be reduced in this way.

The drying apparatus preferably has a roller bed dryer for uniform drying and mixing. A rolling bed dryer is suitable for treating chipped biomass such as wood chips and other organic substances. Because of its functioning, it is suitable for irregularly shaped bulk materials, which require long dwell times for drying at moderate drying air temperatures when the bulk materials have a relatively high initial moisture content. The biomass to be dried is kept in motion with a slowly rotating horizontal stirring paddle in a bed exposed to an oncoming flow of hot air from beneath. The material for drying is then circulated continuously. The paddles are arranged in such a way that the material for drying is conveyed from an entrance to an outlet. While the solids are in motion, the air for drying can flow through them from bottom to top. The solids are therefore in contact with the drying air for a particularly long time, which leads to a uniform result.

The drying apparatus advantageously has a tool for reducing the size of the biomass. It serves to reduce the biomass which is carried into the drying apparatus to a predetermined size in advance in order to thereby facilitate and improve the drying result. Such a tool is preferably a hammer mill or a shredder like a chipping machine, in which the material is milled by a gear constructed of rollers mounted at an offset, a chipping drum or by means of an impact disk.

The drying apparatus and/or the tool for milling is/are advantageously designed for processing wood from thinning forests. In other words, the tool first has rollers and/or impact disks with the help of which such wood from thinnings together with the bark or coupling products can be chipped or shredded and secondly the rolling bed drying has passages through which the wood from thinnings milled with the tool remains within the rolling bed dryer so that heat can always be introduced by way of drying air without causing the chipped wood from thinnings to move out of the rolling bed dryer. Likewise small pieces with a smaller diameter than the passages are already separated in the drying apparatus. The small pieces that are sorted out are preferably collected and sent to another apparatus such as, for example, a heat recovery unit. The tool for chipping is ideally installed upstream from the rolling bed dryer. In this way the biomass can be dried more rapidly and more effectively.

Furthermore, it is preferable if the conveyor apparatus has at least one heat-permeable region, in particular having a base at which biomass can be arranged. With the help of a conveyor apparatus designed in this way, biomass including its bark can be predried already before being sent to a drying apparatus. It is advantageous here in particular if the heat-permeable region is arranged in the bottom of the conveyor apparatus. Therefore, any heat introduced into the conveyor apparatus can be used for predrying the biomass with the bark. In other words, air as the heating medium, for example, can flow easily through the heat-permeable region. Due to the fact that hot air is lighter than cold air and a heat-permeable region is set up in the bottom, an adequate distance is provided, making it possible to transfer heat stored in air to biomass arranged on the heat-permeable region. The bark, in particular the bark of the biomass, can thus be dried.

In addition, it is preferable for the wood processing device to have a shredding apparatus and/or a separation apparatus. With the help of the shredding apparatus, it is possible to further comminute the biomass from the drying apparatus after it is dried. Another finer size reduction of the biomass takes place here.

Furthermore, it is advantageous if the shredding apparatus has a mill which shreds the biomass. A specific embodiment of the mill is a hammer mill whose hammers are designed so that they shred the biomass in an energy-saving manner and separate it into fiber conglomerates in small pieces.

The separation apparatus preferably has at least one sieve, in particular a tumbler sieve for separating the material into at least two separation fractions. The at least two separation fractions are preferably fibers and dust, in particular wood fibers, sawdust, bark dust and non-solid wood constituents such as rotten portions in the tree trunks. With the help of this design, fibers and fiber conglomerates can be classified and processes according to the individual classification groups to yield further products. Accordingly, it is possible to ensure that only high-quality material in the form of suitably classified fibers and/or their conglomerates is processed to create high-quality pellets.

The separation apparatus advantageously has optical means for optical separation into at least two separation fractions. The at least two separation fractions are advantageously fibers and dust, in particular wood fibers and sawdust, bark dust and/or non-solid wood constituents. With the help of optical separation, wood fibers with a high degree of purity can be achieved, wherein the separation of fibers from the totality of the milled biomass can be ensured in such way that not only the dust but also the bark of the biomass is separated almost completely from the fibers. So-called visual recognition can be used to separate fibers, dust and bark because, for example, bark is darker than wood and/or wood fibers.

In addition, it is advantageous if the wood processing device has a buffer. With the help of this buffer, for example, fibers can be stored for further processing after being sieveed in the separation apparatus. Furthermore, it is advantageous if the buffer is arranged on the separation apparatus. In this way, short distances between the separation apparatus and the buffer can be implemented, thus leading to energy savings and space savings in a production building, for example.

In another aspect of the present invention, it is provided that a biomass processing method advantageously proceeds in the following manner.

In a first step, biomass is ideally predried in a conveyor apparatus. In this way the water content of the biomass can be reduced in advance, so that in the next step, less energy must be used for drying, for example. This method is suitable in particular for predrying biomass together with its bark.

Consequently, the biomass is predried before being introduced into the drying apparatus. This saves energy for a subsequent drying apparatus, for example. The biomass is dried mainly on the outside, so that the bark of the biomass can be processed in such a way that the water content of the bark is advantageously reduced. The heating value of the biomass, for example, can therefore be increased.

In a subsequent step, the biomass is advantageously dried with the help of a drying apparatus. The water content of the biomass is further reduced in this way, so that it can be processed to an end product. Consequently, a higher combustion temperature can be achieved in burning the biomass due to the reduced water content, so that an improved combustion or even complete combustion can be achieved. This is because the reduced moisture content in the biomass (so-called wood moisture) does not cause any energy losses due to evaporation of the water stored in the biomass. Therefore, higher temperatures can be achieved in combustion, and carbon monoxide (CO) or wood tar can be prevented. When burning biomass at elevated temperatures, optimum outgassing can take place and thus optimum combustion can be achieved. It is possible in this way to distribute the residual ash, including the fly ash, in meadows, fields and forests.

The biomass is advantageously shredded before being dried in the drying apparatus. This allows simpler and more effective drying because biomass of a certain size can be dried more easily and with less energy than biomass in the form of tree trunks, for example.

In another step, heat is preferably removed from the drying apparatus and sent to a heat-permeable region of the conveyor apparatus. In this way, heat used for drying the biomass inside the drying apparatus is used for predrying inside the conveyor apparatus. This makes it possible to save energy and permits an optimization of the process chain with regard to the energy consumption. Furthermore, waste heat from the drying apparatus can be sent to the conveyor apparatus. This serves as an further energy-saving measure so that, in addition to environmental aspects, the efficiency of the method according to the invention is of course also improved.

The process variable of heat—as already explained—is transferred across a system boundary when there are temperature differences between two systems and/or between the drying apparatus and the conveyor apparatus. In heat transfer, thermal energy, namely heat, is transferred from the system with a higher temperature in the direction of the system with the lower temperature, as described by the second law of thermodynamics. This is true as long as there is a temperature difference between two thermally coupled systems, so that they are not in thermal equilibrium.

For managing heat, for example, from the drying apparatus to the conveyor apparatus, it is advantageous if a fluid, for example, air, is used as the heating medium. It is thus possible to absorb heat at a location where the temperature is higher and then release the heat at another location, where the temperature is lower. It is also possible to use a fluid such as water, oil or silicone instead of air.

In another step, it is advantageous if the biomass is shredded by means of a shredding apparatus. A further homogenization of the biomass is achieved by shredding, so that a high-quality end product can be achieved and/or produced. Furthermore, inclusions in the biomass such as rotten areas or contaminants, e.g., soil, can be separated in this way.

In another step, the shredded biomass is advantageously separated into at least two separation fractions. Separation into fibers and dust in particular into wood fibers and sawdust takes place preferably together with bark. Because of the separation described above, it is possible to supply only high-quality material and/or fibers to the remaining process steps and to filter further components in the form of soil, rotten ingredients, bark and dust out of the process chain. Soil, rotten components, bark and dust are preferably present after separation only in very small amounts. High-quality energy can be produced from the further components due to the optimum separation into high-quality material, such as fibers, and further components such as soil, bark, etc. Therefore, a higher quality product such as pellets can be produced from the biomass raw material by drying and separation. Therefore, the starting material and/or the starting raw material is upgraded as in a refinery.

In another process step, a separation fraction is preferably used for generating heat and/or electricity. Because of the separation into fibers and further components such as dust and bark as described above, the components and/or component products separated from the fibers in this step of the process to generate heat and/or electricity. Consequently, substances and component products produced during the process can also be used within the process chain for further utilization and these can be used in a profitable manner.

Furthermore, in another process step, it is preferable to carry heat generated by burning from a separation fraction, in particular dust and preferably bark, to this drying apparatus. With the help of this arrangement, the process chain is optimized and the components and/or component products that occur within the process chain during production can be used to generate heat, for example. The heat thereby generated may also be used for drying biomass with the help of the drying apparatus described above. Heat can thus be generated from such components as dust, rotten ingredients, bark and/or soil and then used to dry the biomass, as delivered, with the help of a drying apparatus, wherein the heat generated there is sent further and/or is further removed to a conveyor apparatus for predrying the biomass.

In addition, it is preferable to direct the heat produced by generating electricity to the drying apparatus. In this way, the waste heat of a turbine, for example, that is used for generating electricity can be utilized to dry biomass together with its bark in the drying apparatus. Furthermore, the heat introduced into the drying apparatus as well as the waste heat produced there can be used for predrying in the conveyor apparatus. It is favorable here if the heat is directed to the conveyor apparatus after passing through the drying apparatus. It is of course also possible to disburse the heat produced by generating electricity directly to the conveyor apparatus.

In another process step, it is advantageous if heat from the conveyor apparatus is sent to the outside, in particular into the environment. In this way, it is not necessary to implement any further exhaust gas management or the like, so that costs such as the cost of filter maintenance can be eliminated. Releasing the heat directly to the environment is possible because the heat stream and/or the air as a heating medium is preferably purified in advance.

Furthermore, it is advantageous if, in another process step, a separation fraction, in particular fibers, is/are stored in a buffer. Fibers, for example, can be stored with the help of this buffer, after being separated and/or sieveed out in the separation apparatus. The buffer may also be used to homogenize the conglomerates of fibers, so that a mixture of fibers that has been converted to a uniform size can be supplied to another processing stage.

In the method described above, it is advantageous if the process steps described there are carried out with the help of the subject matters of the device described above so that, for example, it is possible to use a separation apparatus of the device for separation in the process or, for example, a separation apparatus for the process step of separation.

According to an further aspect of the present invention, a pelletizing device is provided in particular for producing pellets from biomass.

The pelletizing device here preferably has a drying apparatus for drying biomass. It is possible in this way to dry moist biomass material, such as the bark of trees, but also the wood from tree trunks, for example, to a predetermined water content, which is preferably between 9% and 11%.

The drying apparatus preferably has a rolling bed dryer for uniform drying and thorough mixing. A rolling bed dryer is suitable for treating chips of biomass such as wood chips and other organic materials. Because of its functioning it is suitable for irregularly shaped bulk materials which require long dwell times for drying at moderate drying air temperatures because of its relatively high initial moisture content. The biomass to be dried is moved with a slowly rotating horizontal stirring paddle in a bed exposed to an oncoming flow of hot air. The material for drying is circulated there continuously. The paddles are arranged in such a way that the material for drying is conveyed from an entrance to an exit. While the solids are moving, drying air flows through them from bottom to top. Therefore, the solids are in contact with the drying air for a particularly long period of time, which leads to a uniform result.

The biomass is ideally a fibrous biomass, preferably wood fibers. A fibrous biomass is excellently suited for the production of pellets because fibers impart a high mechanical stability to a pellet as well as having a high heating value.

In addition, it is preferable for the pelletizing device to have a drying apparatus for milling of biomass. Milling of biomass allows a more effective drying within the drying apparatus and thus a simple and energy-saving reduction in the water content of the biomass. The drying apparatus also serves to comminute the biomass carried to the drying apparatus to a certain size in advance to thereby facilitate the drying and improve it. Such a tool is preferably, for example, a hammer mill or a shredder, which is like a chipping machine, in which milling is performed by means of a chipping drum or an impact disk with a gear constructed of rollers mounted with an offset.

The drying apparatus and/or the tool for milling are preferably designed for processing wood from forest thinnings. In other words, on the one hand, the tool has rollers and/or impact disks with the help of which biomass and/or wood from thinnings can be milled together with the bark or coupling products and, on the other hand, the rolling bed dryer has passages through which the wood from thinnings that has been milled using this tool remains inside the rolling bed dryer, so that heat can be introduced continuously by means of the drying air without allowing the milled wood from thinnings to move outward out of the rolling bed dryer. Likewise, small constituents with a smaller diameter than the passages can already be separated in the drying apparatus. The small pieces that are sorted out are advantageously collected and sent to another apparatus.

Furthermore, it is advantageous if the pelletizing device has a press apparatus for pressing pellets. With the help of such an apparatus, one or more pellets can be pressed from the biomass which is preferably in a loose form. In the pressing operation biomass is fed into the press apparatus where the biomass is pressed by a die under pressure by using grinding wheels. The heat released due to friction on the die releases the lignin in wood which imparts dimensional stability to the resulting pellets by lignification. The lignin is then also visible on the outside of the pellets as a shiny surface. Lignin is made of a solid biopolymers which are incorporated into the plant cell wall and thereby induce the lignification of the cell (so-called lignification). Lignin or lignins thus play an essential role in the strength of plant tissues, enabling land-based plants and especially trees to withstand the mechanical stresses due to gravity and environmental influences such as wind and weather.

Furthermore, it is advantageous if the pelletization device has a cooling apparatus for cooling the pellets. While pressing pellets in a press apparatus, heat is generated because of the high degree of friction between the biomass and the die through which the biomass is pressed, with the biomass and/or its fibers preferably reaching a temperature of 95° C. to 110° C. during the pressing operation. A lower temperature, such as 95° C. is preferably achieved with a soft biomass such as pine, and a temperature of 105° C. is used with a hard biomass such as beech. By setting the temperature and/or the heat to be introduced into the biomass, the output of lignin for the respective biomass is achieved.

This heat is found both in the die of the press apparatus as well as in the finished pellets. After being pressed in a press apparatus the pellets have a temperature between 95° C. and 108° C. In this way, the lignin in the fibers is activated, so that lignification of the pellets is made possible, and activation of lignin makes it possible to avoid adding binders.

To be able to utilize the energy stored in the pellets in the form of heat for further apparatuses and/or process steps, the heat is preferably carried from the cooling apparatus to the drying apparatus. It is advantageous if a heat dissipation channel of the cooling apparatus is connected to a heat supply channel of the drying apparatus. The heat can be guided effectively and rapidly from the cooing apparatus to the drying apparatus in this way. With the help of the heat obtained from the cooling apparatus, the biomass carried for drying in the drying apparatus can be dried effectively and in an energy-saving process. Thus the heat generated in the press apparatus can be used for drying biomass.

Furthermore, it is advantageous if the device has a first conditioner, which advantageously detects the water content of the biomass, in particular by means of ultrasound. Thus the water content in the biomass can be detected by a simple method. Furthermore, it is advantageous if the first conditioner adjusts the water content of the biomass by means of water from a first water dosing apparatus to a water content between 7% and 13%, preferably to a water content of 9.5-11%. With the aid of adaptation of the water content, mechanical parameters of the biomass can be adjusted on their path through the pelletizing device. It is thus possible with the help of the aforementioned water content to press pellets and also to carry the biomass through the pelletizing device. In particular when the water content is between 9.5% and 11%, an adequate water film is formed between the biomass and a conveyor chute, for example, in which the biomass is carried. This permits lubrication by the biomass on conveyor lines, so that the friction between the biomass and the conveyor line is reduced and the energy consumption for conveyance of the biomass can be reduced. Furthermore, the water contained in the biomass evaporates due to the friction between the biomass and the die created during production, so that pellets with a water content below the EU standard ENplus A1 or A2, for example, and thus with a high heating value can be obtained.

The pelletizing device ideally has a ripening device where the biomass, in particular fibers, is preferably stored temporarily and mixed thoroughly. It is therefore possible to absorb the water introduced by a conditioner in the biomass and/or to give the biomass an opportunity to take up water and store it.

In addition, it is preferable for the device to have a second conditioner with which it is advantageous to detect the water content of the biomass, in particular by means of ultrasound. Therefore, the water content of the biomass can be tested again. The second conditioner advantageously adapts the water content of the biomass by means of water from a second dosing apparatus. It is advantageous here if the water content is adjusted to a level between 7% and 13%, preferably to a water content of 9.5-11%. The second conditioner has the advantage that the measurement and adjustment within the first conditioner are controlled and corrected, if necessary.

With both the first conditioner and the second conditioner, it is advantageous if the water content is increased by using hot water, preferably by spraying with hot water. The heat stored in the biomass is retained in this way and is not exchanged. Thus the heat as a process variable can remain in the process and be used further.

Furthermore, it is advantageous if the pelletizing device comprises a sorting apparatus for sorting the pellets. With the help of the sorting apparatus, solid constituents (such as fibers) bound in pellets can be separated from loose components (such as dust) after the pellets have been pressed. It is possible in this way to obtain only pellets of a certain size and shape as the end product. This also makes it possible to achieve a specified standard such as the EU standard ENplus A1 or ENplus A2.

The pelletizing device preferably has a mixing apparatus, which combines the heat obtained in cooling the pellets with other heat streams, in particular from other equipment. Consequently, with the help of the mixing apparatus, the heat obtained by cooling the pellets can be combined and/or mixed with other heat streams from other equipment, such as the waste heat from turbines or from turbine cooling, and transferred to the mixing apparatus.

Furthermore, it is advantageous if the pelletizing device has at least one storage cell, in which the pellets that are produced can be stored after being sorted in the sorting apparatus and then can advantageously be loaded as loose material and/or bagged and/or gasified to generate green power. Due to the loose loading, the pellets that are produced can be filled into silo trucks in large volumes. Bagging allows predetermined quantities of pellets in bags to be sold to the final consumer for heating a residential apparatus. Gasification of the pellets permits the production of green power as an immediate use of the pellets in a connected green power plant. In addition, it is preferable to keep on hand a storage cell for pellets according to the ENplus A1/A2 standard. Production can be carried out in the storage cell, for example, when starting operation of a plant with the pelletizing device or when resuming operation after elimination of a problem until all the parameters have been adjusted and checked for further production (for example, in accordance with the production handbooks).

According to another aspect of the invention, a method for producing pellets, preferably wood pellets, includes the following steps.

One step advantageously comprises drying the biomass with the help of a drying apparatus. The biomass is advantageously a fibrous biomass, preferably wood fibers. By drying the biomass, first, a higher heating value for the biomass is achieved and, second, this step also serves to further process the biomass to pellets. The drying is preferably performed with the help of a drying apparatus, which is preferably a rolling bed dryer for uniform drying and thorough mixing. A rolling bed dryer is suitable for treating chips of biomass such as, for example, wood chips and other organic substances. Because of its functioning, it is suitable for irregularly shaped bulk materials, which require long dwell times for drying at moderate drying air temperatures because of the relatively high initial moisture content. The biomass to be dried is moved by means of a slowly rotating, horizontal stirring paddle in a bed that is exposed to oncoming hot air flow from underneath. The material for drying is kept constantly in circulation. The paddles are arranged in such a way that the material for drying is conveyed from an entrance to an outlet. While the solids are kept in motion, the drying air, which is preferably at a temperature of 90° C. to max. 105° C., is preferably flowing through the solids from bottom to top. The solids are therefore in contact with the drying air for a particularly long period of time, which leads to a uniform result.

Another step advantageously includes pressing the biomass to form pellets with the help of a press apparatus. A press apparatus advantageously has a die as well as at least one grinding wheel, with the help of which the biomass is pressed through the die. In this process, heat is generated both in the die and in the pressed biomass.

In another process step, the pellets are advantageously cooled with a cooling apparatus. In this way, the heat generated in the pellets by pressing is withdrawn from the pellets, so that they can be stored and then subsequently loaded and packaged at room temperature.

In another step of the process for producing pellets, heat is preferably taken from the cooling apparatus and sent to the drying apparatus. In this way, the heat removed in cooling the pellets can be used for drying biomass in the drying apparatus. It is thus possible to save on the energy for the drying apparatus and/or for heat used for drying inside the drying apparatus. Furthermore, the efficiency of such a method is increased. Furthermore, such a method is optimal with regard to environmental aspects because the heat generated in a process is reused and does not remain unused in the process chain or even dissipated.

In another process step, the water content of the biomass is preferably determined after drying. This is advantageously done by means of ultrasound. Because of the fact that there is excellent propagation of ultrasound in a dense medium such as water, the water content can be determined easily on the basis of the signal received from an ultrasonic transmitter because the water content is higher, the more intense the signal and/or the closer the received signal to the output signal. The determination of the water content is used for reducing the friction between the biomass and a conveyor chute in which the biomass is carried, for example. Therefore, the biomass can provide lubrication on the conveyor lines, so that the energy consumption for conveying the biomass can be reduced.

Furthermore, in another process step, it is advantageous if, after determining the water content of the biomass, the water content is increased by means of water from a first water dosing apparatus. The water content is advantageously set between 7% and 13%, preferably 9.5-11%. The water thereby introduced serves to improve the lubrication between the biomass and a conveyor chute. This water content can easily escape due to friction in the die during production and/or pressing of pellets so that pellets with a low water content and a high calorific value are obtained.

Furthermore, it is advantageous if the biomass is stored temporarily in a ripening apparatus, where it is mixed thoroughly. In this way, the water content of the biomass can be made more uniform because the temporary storage and thorough mixing of the biomass present the possibility of uptake of water and storage of water. This water provides lubrication for the biomass on a conveyor chute, for example, and/or on conveyor lines.

The water content is advantageously determined once again after making the water content of the biomass more uniform. This is advantageously done by means of ultrasound. Since there is excellent propagation of ultrasound in a dense medium such as water, for example, the water content can be determined easily on the basis of the received signal of an ultrasonic transducer, as already described above. The water content is higher, the closer the received signal is to the output signal. For the case when the water content is different from the target value, it is preferable to increase the water content by means of water from an further water dosing apparatus after the water content of the biomass has been determined. The biomass is advantageously adjusted to a water content between 7% and 13%, preferably to a water content of 9.5-11%. As already mentioned, the friction of the biomass on a conveyor chute can be reduced easily with the help of this water content. This water content can also escape easily due to friction in the die in the production of pellets, so that pellets with a low water content and a high calorific value can be produced.

In addition, it is advantageous if the biomass is heated to a predetermined temperature by pressing the biomass to form pellets with the help of the press apparatus. This is preferably done at a temperature between 85° C. and 115° C. The biomass is preferably heated to a temperature between 98° C. and 105° C. It is possible to activate the lignin in the biomass in the aforementioned temperature range, which is achieved during pressing of the biomass by the die of a press apparatus with the help of grinding wheels. This acts as a binder, so that artificial additives can be omitted. Lignin imparts a shiny surface and also a high dimensional stability to the pressed pellets because the lignin is responsible for the lignification of the biomass.

In another process step, it is advantageous to dissipate the heat of the pressed pellets to cool the pellets to a predetermined temperature, preferably room temperature. The dissipated heat is preferably sent to the drying apparatus, where it is used for drying the biomass. Energy and costs can therefore be saved. The heat generated in the press apparatus can therefore be used further for drying the biomass.

Furthermore, in another process step, it is advantageous to combine heat recovered in cooling the pellets with other heat streams. The heat is preferably combined with heat streams from other areas of the process. For example, it is possible to combine heat from the cooling apparatus with waste heat from a turbine, for example, and its turbine cooling and to convey it further. For example, the heat is used in one or more so-called ORCs and/or in a plant in which waste heat is coupled to work to generate electricity.

An ORC is preferably a plant with coupling of waste heat and power and/or a so-called organic Rankine cycle (abbreviated ORC), in which steam turbines are operated with a different working medium than steam, such as certain oils (e.g., silicone oil), for example, with a low evaporation point. Such a process and/or such a plant is/are then preferably used when the available temperature gradient between the heat source and the heat sink is too low for operation of a steam-driven turbine.

Furthermore, it is advantageous to sort the pellets after cooling. This is advantageously accomplished by means of sieveing. A tumbler sieve or vibrating sieve is advantageously suitable for this purpose. Such a sieve has a simple design and separates pellets of a certain size from smaller chopped residues or chopping wastes, so that filling of high-quality pellets that conform to a standard such as the EU standard ENplus A1 or ENplus A2 can be ensured.

In addition, in another process step it is preferable to store the pellets after being sorted. The stored pellets can advantageously be loaded and/or bagged as loose pellets and/or can be gassed for generating green power. The pellets thus produced can be shipped in large quantities in silo trucks and conveyed to consumer sites, for example, thanks to this bulk loadability. By bagging the pellets, it is possible to sell predetermined quantities of pellets in bags to the end user for heating a residential unit. By gasifying the pellets to generate green power, immediate use of the pellets in a connected green power plant is possible.

The device described above as well as the method furtherly include a defibration apparatus for defibration or pulping (for example, a mill), a separation apparatus for separation (for example, a sieve) and a buffer for temporary storage. The aforementioned apparatuses and/or objects and process steps are preferably set up between the press apparatus and the drying apparatus. With respect to further features and embodiments of the shredding apparatus, the separation apparatus and the buffer, reference is made to the preceding discussion of the other aspects of the invention, which are also applicable here.

With the method described above, it is advantageous if the process steps that are described are carried out with the help of the subject matters of the device described further above, so that it is possible, for example, to use a sorting apparatus for the process step of sorting.

In another aspect of the invention, a device for generating energy from biomass is provided. It ideally has a heat recovery apparatus for generating heat and a drying apparatus.

A heat dissipation channel of the heat recovery apparatus is advantageously connected to a heat supply channel of the drying apparatus. Therefore heat can be transferred from the heat recovery apparatus to the drying apparatus. The drying apparatus is preferably a rolling bed dryer for uniform drying and thorough mixing of biomass in particular wood from forest thinnings.

The drying apparatus preferably has a rolling bed dryer for uniform drying and thorough mixing. A rolling bed dryer is suitable in particular for chips of biomass such as wood chips and other organic materials. Because of its structural design, it can dry bulk goods, which require long dwell times for drying at moderate drying air temperatures, starting from a relatively high initial moisture content. The biomass to be dried is kept in motion by means of a slowly rotating horizontal stirring paddle in a bed through which hot air flows from beneath. In doing so, the material for drying is kept in constant circulation. The paddles are arranged in such a way that the material for drying is conveyed from an entrance to an outlet. While the solids are in motion, the drying air, preferably at a temperature of 90° C. to max. 105° C. flows through the solids from bottom to top. Therefore the solids are in contact with the drying air for a particularly long period of time which leads to a uniform result.

Furthermore, a drying apparatus advantageously has a tool for milling of biomass. The drying apparatus as well as the tool for milling are advantageously designed for processing wood from forest thinnings and coupling products. In other words, first of all, the tool has rollers, chipping drums or impact disks with the help of which milling of wood from forest thinnings is possible and, secondly, the rolling bed dryer has passages through which the wood from thinnings milled with the tool remains within the roller bed dryer so that heat can constantly be introduced by way of the drying air without causing the milled wood from thinnings to move outward out of the rolling bed dryer. The tool for milling is ideally installed upstream from the rolling bed dryer. In this way the biomass can be dried more rapidly and more effectively.

Furthermore, it is preferable if a mixer is used for mixing hot fluid from the heat recovery apparatus with cool fluid to lower the temperature of the hot fluid. In this way, the heat contained in the hot fluid is distributed over a larger amount of fluid, so that the temperature of the mixed fluids drops in comparison with the temperature of the hot fluid. In this way, not only is a temperature reduction achieved but also heat generated by the heat recovery apparatus is distributed over a larger mass stream. This has the advantage that fluid with a high thermal content and/or at a high temperature is rendered usable for further use within the device.

Furthermore, it is preferably for a separation apparatus to free the fluid from the mixer of contaminants. In this way contaminants introduced into the heat recovery apparatus by burning sawdust, bark dust and non-solid wood constituents, e.g., fine dust to be filtered out. This advantageously takes place with the help of the centrifugal force. In this way, the use of expensive filter sieves is not necessary because, with the help of centrifugal force, a continuous filter is implemented without replacement and with a low cleaning expense.

Furthermore, it is advantageous if the device has at least one turbine. Heat from the heat recovery apparatus and/or from the mixer is ideally supplied to the turbine for generating electric power. The turbine can be operated with the help of the heat thereby recovered from the heat recovery apparatus. This converts thermal energy, i.e., heat, into mechanical energy, i.e., work. Mechanical energy can thus be generated from heat and/or current and voltage, i.e., electricity, can be generated by conversion of mechanical energy into electric power. It is possible for the heat from the heat recovery apparatus to be sent directly to the at least one turbine, preferably an ORC or to the mixer describe above.

The device preferably has a mixing apparatus, which receives waste heat from at least one turbine. It is also possible to receive heat generated by cooling the at least one turbine in the mixing apparatus. Other heat streams in particular from other areas of the device may advantageously be combined in the mixing apparatus. It is thus possible to combine heat from at least one turbine with heat from a cooling apparatus for pellets, for example, and to bring it to a predetermined temperature of 105° C., for example.

According to another aspect of the invention, a method for generating power from biomass is provided. This preferably makes use of fibrous biomass, in particular wood fibers. Furthermore, this method advantageously uses a device for generating energy from biomass such as that described above.

One step according to the invention comprises the generation of heat by burning milled biomass, in particular sawdust and bark. Milled biomass consists largely of components that have been reduced to such an extent that they are largely in the form of dust and/or bark. Such small pieces are difficult to bind, for example, for the production of pellets. This biomass is nevertheless combustible and can thus be burned for generating heat.

Another step according to the invention advantageously provides for drying of biomass with the help of heat generated by burning. In this way the heat obtained from milled biomass can be used for drying biomass. Thus, for example, biomass can be processed with bark in such a way that the water content of the bark in particular is reduced so that the heating value of the biomass is in turn increased. Consequently, the combustion temperature can be increased when burning a biomass treated according to the invention because due to the reduced moisture content in the biomass (so-called wood moisture) less heat is needed for evaporation of the water stored in the biomass. Thus the combustion flames reach higher temperatures and it is possible to achieve so-called complete combustion, while substances such as carbon monoxide (CO) or wood tar can be prevented.

Furthermore, in another process step, it is advantageous to further utilize the heat thereby generated to drive at least one turbine for generating electricity. Thus thermal energy can be converted into mechanical energy, and mechanical energy can be converted into electricity. The heat is preferably utilized in a so-called ORC, i.e., a plant in which waste heat is coupled to power in order to generate electricity.

An ORC is preferably a plant with a coupling of heat and work in a so-called organic Rankine cycle (abbreviation ORC), in which steam turbines are operated with a different process medium than steam, such as, for example, certain oils (e.g., silicone oil), which have a lower evaporation temperature. Such a process and/or such a plant are then preferably used when the available temperature gradient between the heat source and the heat sink is too low for operation of a steam-driven turbine.

In addition, it is advantageous to store the heat thereby generated in a fluid and to reduce the temperature of the fluid by mixing it with another fluid. In this way the heat contained in a hot fluid is distributed to a larger volume of fluid so that the temperature of the combined fluids is lower in comparison with the temperature of the hot fluid. In this way, not only is a reduction in temperature achieved but also heat is distributed to a larger mass stream. This has the advantage that fluid with a high heat content, i.e., at a high temperature, is made usable for further utilization. The fluid is preferably air because this has already advantageously been produced in a heat recovery apparatus.

In addition, it is favorable in one process step if a separation apparatus filters soiling out of the fluid. This is preferably accomplished by means of centrifugal force. In this way soiling originating from burning sawdust, bark dust as well as non-solid wood constituents in the heat recovery apparatus such as fine dust, for example, can be filtered out. Due to the use of centrifugal force, it is not necessary to use expensive filter sieves because a continuous filter can be implemented without needing replacements and with a low cleaning expense by using centrifugal force.

In another process step, it is favorable to dissipate the exhaust heat of the turbines and/or heat produced by cooling of the turbines. The heat and/or exhaust heat is/are preferably combined with other heat streams. The other heat streams are preferably combined from other areas of the process such as, for example, cooling for pellets. Heat can be collected in this way and sent to a location in a targeted manner.

With the method already described it is advantageous if the process steps that have been described are carried out with the help of the subject matters of the device described above. For example, it is possible to use a heat recovery apparatus of the device for burning biomass.

The features described above can all be combined with one another. For example, it is possible to combine the features of the biomass processing device with those of the pelletizing device and with those of the device for generating power from biomass. The features of the biomass processing method can of course be combined with those of the method for producing pellets and with those of the method for energy recovery from biomass. It is also possible to combine the aforementioned devices with the methods.

It is also advantageous that in the invention presented here the heat generated can advantageously be transferred from the site of its production, such as the heat recovery apparatus, for example, to the drying apparatus and preferably onto the conveyor apparatus without having to pass the heat through a heat exchanger, where high losses occur. This is advantageously accomplished by the fact that air is used as the heating medium. In this way, heat produced by combustion and stored in air can be collected by the individual apparatuses, without the losses that necessarily occur with a heat exchanger, and then disbursed to the biomass at a site of use (drying apparatus and/or conveyor apparatus).

In an alternative embodiment of the invention, an apparatus for utilizing the material of wood fibers is provided, wherein the device is connected to a biomass processing device according to any one of the preceding configurations, and the device has means for processing the fibers to from an intermediate or end product.

Operation of the connected biomass processing device is preferably set up so that fibers can be produced to predetermined specifications.

The utilization of the material of the fibers taken from the biomass processing device preferably comprises the production of a multicomponent element, for example, a plastic composite material element, which is formed by using the wood fibers as a reinforcing material.

In addition, preferably an injection molding device is provided for utilizing the material of the fibers, this injection molding device being equipped to produce fiber-reinforced plastic parts using the fibers obtained from the biomass processing device.

In an alternative embodiment of the invention, a method is provided for utilizing the material of wood fibers, wherein the method according to any one of the preceding configurations is used to generate fibers that can be used as a raw material, whereas substances that cannot be used as material are sent for utilization as energy.

The utilization of the material here is preferably carried out by means of a process which is essentially coupled directly to the process for producing the fibers by the method according to any one of the preceding configurations.

The invention is explained in greater detail below on the basis of exemplary embodiments in conjunction with the respective drawings.

The invention, which relates to a biomass processing device, a pelletizing device and a device for producing energy from biomass is described below. The devices that have already been described can be combined with one another, as will be demonstrated.

Furthermore, the invention relating to a bioprocessing method, a method for producing pellets and a method for recovery of energy from biomass is also described below. The methods that have already been described can be combined with one another, as will be demonstrated.

It is also possible to combine the aforementioned devices with the methods.

The drawings show schematically:

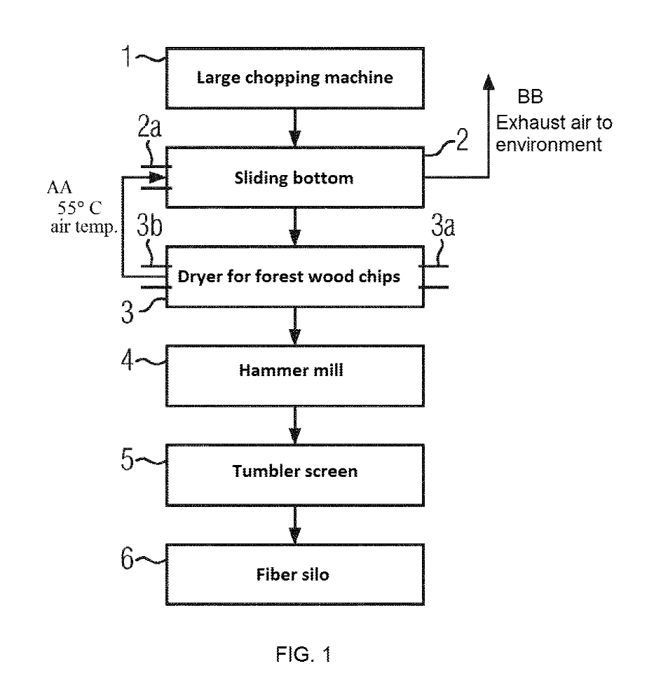

FIG. 1 shows a flow chart and a biomass processing device,

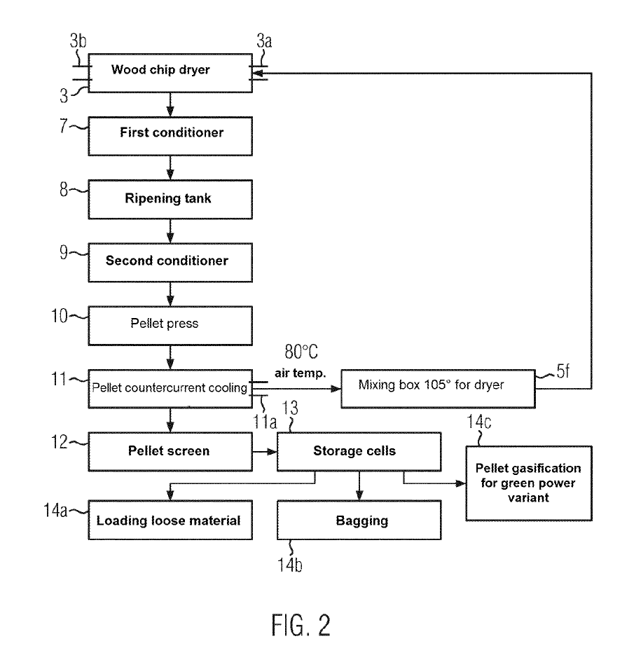

FIG. 2 shows a flow chart and a pelletizing device for producing wood pellets,

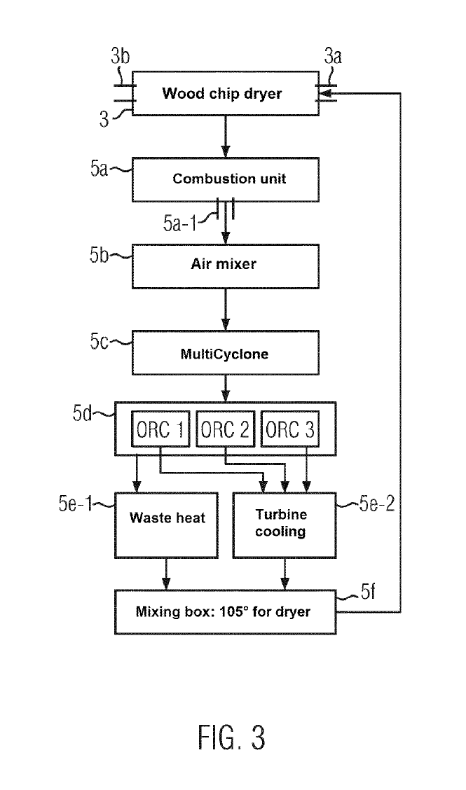

FIG. 3 shows a flow chart and a device for generating energy from biomass and

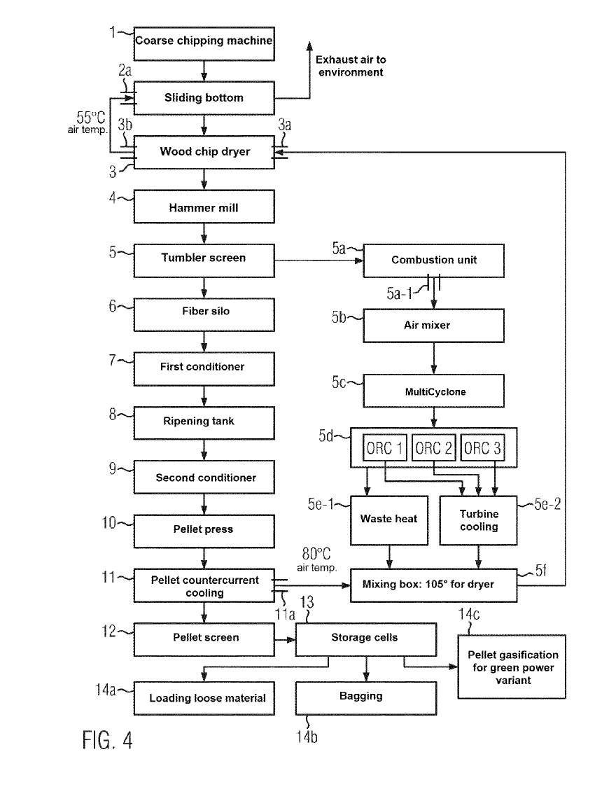

FIG. 4 shows a flow chart and a production plant with a biomass processing device, a pelletizing device for producing wood pellets and a device for generating energy from biomass.

In the following description of FIGS. 1 through 4, the same reference numerals denote the same objects.

FIG. 1 shows a flow chart and a biomass processing device for wood from forest thinning and coupling products such as tree tops. The device has a coarse chopping machine 1 for wood of all types from forest thinnings, a sliding bottom 2 for wood chips and/or a sliding bottom as a conveyor apparatus and a wood chip dryer 3 as the drying apparatus.

The coarse chopping machine 1 shreds the wood from forest thinnings as delivered to yield wood chips. Wood from forest thinnings includes, for example, tree trunks, branches and shrubs as well as Miscanthus giganteus and all other rapidly growing plants and energy woods. Wood from forest trimmings also has moist bark. In milling by the coarse chopping machine 1, smaller units such as G 20 to G 60, preferably G 30 to G 40 are also produced according to the European chip standard EN 14961. Other sizes are of course also possible. In this way, for example, entire tree trunks together with their bark can be milled in advance.

The milled wood from forest thinnings and/or the wood chips together with their bark are shaken on the sliding bottom 2. The sliding bottom 2 has a double bottom as a heat-permeable region, which has obliquely slotted plates so that air can flow through the double bottom and/or through the wood chips on the sliding bottom. The length and width of the sliding bottom 2 for wood chips are designed, first of all, for the required quantity of wood chips for production of wood pellets and, secondly, the length of the wood chip sliding bottom 2 in particular is designed for reducing the water content of the wood chips by approx. 1-9%. Consequently, with the help of the sliding bottom 2, wood chips with bark and other biomasses can be predried, but attention must be paid to the correct height of the bed (2 to 6 meters).

As shown in FIG. 1, the wood chip dryer 3, which receives the wood chips and conveys them by means of a metering screw (not shown) from the sliding bottom 2 for the wood chips to the rolling bed dryer, is connected to the sliding bottom 2. The wood chip dryer 3 comprises a rolling bed dryer and optionally includes a die for further milling of the wood chips (neither is shown here), wherein the die for milling is ideally arranged upstream from the rolling bed dryer. In this way, the biomass can be dried more quickly and more effectively.

A tool for milling may be, for example, a wood chipping machine, which performs a milling of the wood chips to a defined chip size by using a gear constructed with rollers mounted with an offset, by means of chipping drum or by means of an impact disk. A predetermined chip size is understood, for example, for the European wood chipping standard EN 14961. With this standard a main fraction (amount by weight >60%) with parts of a size of 2.8 . . . 16 mm and a diameter of ø 30 mm are represented, for example, along with fines (amount by weight <20%) in portions smaller than (<) 2.8 mm and a coarse fraction (amount by weight <20%) with portions greater than (>) 16 mm With regard to further standards, reference is made to the relevant technical literature.

The rolling bed dryer essentially has a drum through which heat can pass plus paddle rollers which convey the milled wood chips through the drum from an entrance to an outlet.

Because of its functioning, the rolling bed dryer is suitable for bulk materials which require long dwell times for drying because of their relatively high initial moisture content. The wood chips to be dried are kept in motion using a slowly rotating paddle roller in a bed with an oncoming hot air flow from beneath, guiding and/or shifting the wood chips through the rolling bed dryer 3 and/or its drum. In doing so, the milled wood chips are circulated constantly together with their bark. The slow rotational movement of the paddle rollers permits a good and thorough mixing of the wood chips in the drum and ensures that the water content of the wood chips is reduced from approx. 40% to 9-10% before the chips enter a discharge screw of the dryer. While the wood chips are in motion, hot drying air, preferably at a temperature from 90° C. to max. 105° C., flows around them from bottom to top. The wood chips therefore remain in contact with the drying air for a particularly long period of time, which leads to a uniform result.

Because of the constant introduction of hot air for drying the milled wood chips, the rolling bed dryer and/or the wood chip dryer 3 also has a heat dissipation channel 3b in addition to a heat supply channel 3a for introducing hot air. The air introduced is removed from the rolling bed dryer through the heat dissipation channel after transferring its heat to the wood chips.

The sliding bottom 2 has a heat supply channel 2a which is connected to the heat dissipation channel 3b of the rolling bed dryer. Thus the heat remaining in the air is used further after passing through the rolling bed dryer to predry the wood chips on the sliding bottom 2. Therefore the heat supply channel 2a of the sliding bottom 2 is connected to the above-mentioned double bottom as a heat-permeable region, so that the heat remaining in the air directly strikes the wood chips arranged and/or poured as a bed onto the sliding bottom 2.

As already explained above, the drum and/or a basket of the rolling bed dryer and/or of the wood chip dryer 3 is designed to be air permeable. Therefore, passages having a predetermined diameter are provided in the rolling bed dryer, so that the small pieces with a smaller diameter than the passages are already separated in the drying apparatus. These small constituents such as dust can thus be separated and collected already in advance as well as being sent to another device for further processing such as, for example, to a heat recovery unit embodied as a combustion unit 5a.

Furthermore, the biomass processing device for wood from forest trimmings and coupling products has a separator for metal and heavy materials, as well as a hammer mill as a shredding apparatus, a separation apparatus as a tumbler sieve and a buffer as a fiber silo.

All the other components such as bark and fibers of the milled wood chips enter a discharge screw leading to a separator for metal and heavy materials (not shown) after passing through the wood chip dryer 3. By using a magnetic roller, this separator separates the metal and iron parts into a container set up separately. The separator for heavy material also conveys rocks and nonwoody components into a container.

Following that, the milled and dried wood chips are conveyed for further milling into a shredding apparatus embodied as a hammer mill 4. The hammer mill 4 has specially designed hammers which are arranged on a rotor and pulp the bark, for example, and non-solid forest wood chippings such as sawdust and rotten portions in tree trunks. Furthermore, the solid wood chips in the form of wood are shredded, so that fibers and conglomerates of wood fibers are formed.

The rotor of the hammer mill 4, with its hammers and/or beating of its hammers, rubs the milled wood chips through a sieve, which is arranged around the rotor. This produces an optimum length for the conglomerates of wood fibers and/or individual wood fibers.

Based on the dry properties of the wood chips, the hammer mill 4 also has a fan to produce a vacuum in the rotor region. Therefore all the wood chips comprising fibers and bark, bark dust and sawdust are removed by suction in the hammer mill 4. This removal ensures a uniform vacuum in the rotor region of 0.2 to 0.9 millibar. Thus an optimal efficiency of the hammer mill can be achieved, while no wood chips are lost at the same time. The air that is removed by suction can be cleaned through a filter and vented to the outdoors or used further in another apparatus within another process.

Inside the hammer mill 4 or after discharge of the milled wood chips form the hammer mill 4, the wood chips are classified to sort out the fines, such as dust of a certain size, for example.

This classification is performed following the hammer mill 4, using a tumbler sieve 5 as the separation apparatus, into which the pulped and/or milled and/or shredded wood chips are conveyed. The tumbler sieve has four sieve levels, which separate the wood fibers from the bark and the sawdust and/or bark dust as well as non-solid wood constituents such as rotten portions of tree trunks. The individual sieve levels differ from one another due to different mesh sizes, wherein different separation fractions of wood fibers are also achieved. At the top level, the pulped wood chips that will not pass through the sieve level with the largest mesh are separated. The mesh decreases in size successively from one sieve level to the next sieve level, so that ideally only pulped and/or shredded wood chips on the order of magnitude of sawdust, bark dust as well as non-solid wood constituents are ideally collected at the fourth level. Consequently, the shredded wood chips can be classified into four separation fractions in this way.

Alternatively, it is also possible to use optical means for optical separation of wood fibers and sawdust. For example, the milled wood chips will be allowed to fall a predetermined distance for this purpose. In doing so, cameras at the start of the path detect the size of the individual pieces of the wood chips. Air jets also installed along the path but situated beneath the cameras classify the individual pieces of the wood chips in containers provided for this purpose by means of targeted control as a result of an analysis of the camera capture. This is accomplished by having the air jets separate the respective classes of wood chips from one another by means of air in a targeted manner Visual recognition may also be used because, for example, bark is darker than wood or wood fibers.

The separation fraction of the fourth sieve level, i.e., the sawdust, the bark dust and the non-solid wood constituents, is transported like the bark separation fraction to an intermediate buffer (not shown) for further processing and utilization by means of a conveying screw.

The fractions of the first three sieve levels are transported in a conveying screw to a fiber silo 6 as buffer or to the first conditioner 7. At low outside temperatures, more power is required for the drying so the third sieve stage or other sieve stages may also preferably be used for the heat recovery plant.

When there is a disturbance fiber silo 6 serves as into which classified shredded wood chips and/or wood fiber material are conveyed. Furthermore, the fiber silo 6 serves to buffer fluctuations in the processes described above and/or in the equipment described above, so that the downstream equipment and/or steps can be carried out continuously and without interruption. Consequently, the buffer serves to provide temporary storage if there is a stoppage in the downstream production. Furthermore, it is possible to use the fiber silo for admixture of dry wood shavings and sawdust and thus to further improve utilization of the downstream production processes.

The device discussed above is suitable for carrying out a process in which wood of all types from forest thinnings plus the coupling products from a coarse chipping machine 1, which comminutes the wood from forest thinnings and the coupling products, into a sliding bottom for wood chips, which are sent from a coarse chipping machine into a sliding bottom in the first process step of the flow chart according to FIG. 1.

For the drying of the wood chips in the sliding bottom 2, exhaust air from the heat dissipation channel 3b of the wood chip dryer 3 is carried through tangential slot plates in the sliding bottom 2. At the same time, the wood chips are carried out of the sliding bottom 2 into the rolling bed dryer 3, i.e., the wood chip dryer 3 to continue the drying begun in the sliding bottom 2 for the wood chips.

After drying the wood chips in the rolling bed dryer of the wood chip dryer 3, the wood chips are sent to a mill 4 for shredding. The fibers and conglomerate of fibers thereby obtained are then classified in a tumbler sieve 5. In doing so, the shredded wood chips are separated into separation fractions such as fibers, wood fibers of bark and sawdust and/or bark dust as well as non-solid wood constituents (sawdust and rotten portions of tree trunks) in a plurality of sieve levels.

Following this the individual classified separation fractions are stored temporarily in one or more buffers which receive the dried and shredded wood chips in the event of stoppage in the downstream production.

FIG. 2 shows a flow chart and a pelletizing device for production of pellets from biomass, in particular from wood from forest thinnings. The pelletizing device comprises a wood chip dryer 3 as a drying apparatus, a pellet countercurrent cooling 11 as a cooling apparatus for cooling the pellets and the pellet press 10 as a press apparatus for pressing the pellets.

Upstream from the pellet press, there is a wood chip dryer 3, comprising a rolling bed dryer and optionally a tool for further milling of the wood chips.

The tool for milling may be, for example, a chipping machine which performs the milling of the wood chips into defined chip sizes by means of a gear constructed of rollers mounted at an offset, by means of a chipping drum or by means of an impact disk. In the event such a tool is used, it is advantageously installed upstream from the rolling bed dryer.

The rolling bed dryer has essential a drum and/or basket through which heat can flow as well as paddle rollers, which convey the milled wood chips through the drum from an entrance to an outlet.

Because of its functioning, the rolling bed dryer is suitable for bulk materials, which require long dwell times for drying because of the relatively high initial moisture content. The wood chips to be dried are kept in motion by means of the slowly rotating paddle rollers in a bed with oncoming flow of hot air from beneath, moving and/or pushing the wood chips through the rolling bed dryer of the wood chip dryer 3 and/or its drum. In doing so the milled wood chips are kept constantly in circulation. The slow rotational movement of the paddle rollers permits good and thorough mixing of the wood chips in the drum and ensures that the water content of the wood chips is reduced from approx. 40% to 9-10% before it enters a discharge screw of the dryer. While the wood chips are in motion, hot drying air preferably at a temperature of 90° C. to max. 105° C. flows around them from bottom to top. These chips are therefore in contact with the drying air for a particularly long period of time, which leads to a uniform result.

Because of the constant introduction of hot air for drying of the milled wood chips, the rolling bed dryer also has a heat dissipation channel 3b in addition to a heat supply channel 3a for introducing hot air. The air introduced is carried out of the rolling bed dryer 3 through the heat dissipation channel after having transferred its heat to the wood chips.

Furthermore, the pelletizing device for producing pellets from biomass, in particular from wood from forest thinnings has a first and a second conditioner 7, 9 as well as a ripening tank 8, a pellet sieve 12 as a sorting apparatus and storage cells 13.

The wood chip dryer 3 is connected to a first conditioner 7 for adjusting the temperature of the material that occurs during the drying process. Separation fractions of a hammer mill 4 (not shown), which have been classified according to the fines of a certain size, such as dust, bark and/or fibers, are conditioned in the first conditioner 7. Thus shredded wood chips of a certain classification enter the first conditioner 7. The shredded wood chips are fibers of biomass, in particular wood of all types from forest thinnings, such as, for example, deciduous wood, such as, for example, ash, chestnut, birch, beech, etc., or softwood from coniferous trees, such as, for example, yew, spruce, fir, etc., or shrubs, such as, for example, ivy, pyracantha, blackberry or the like or an energy carrier such as Miscanthus giganteus.

The shredded wood chips are conveyed by means of a conveying screw (not shown) to the first conditioner 7. The temperature of the shredded wood chips upstream from the conditioner is between approx. 40° C. and 50° C. The heat stored in the wood chips is introduced into the wood chips through the wood chip dryer 3 and the hammer mill 4 (not shown). Maintaining the temperature of the material is important for further processing, in particular for processing to form wood pellets, because lignin is released only at a temperature above approx. 95° C. Lignin comprises solid biopolymers, which are incorporated into the cell wall of the plant and thereby cause the lignification of the cell (so-called lignification). Lignin and lignins are thus essential for the strength of plant tissues. These substances make it possible for land-grown plants and trees in particular to withstand the mechanical stresses caused by the force of gravity and environmental influences such as wind and weather.

In summary, the wood chips are sent to the first conditioner 7 after drying. The first conditioner 7 has a measurement station, a water dosing apparatus and a paddle mixer. The paddle mixer conveys the wood chips through the first conditioner from an entrance to an outlet with the help of paddles.

With the help of the measurement station, the water content of the wood chips is detected by means of ultrasound so that the wood chips can be sprayed and/or moistened with hot water if necessary by means of the water dosing apparatus. As a rule the fibers of the wood chips are introduced with a water content of 9-10%. For the case when an ultrasonic analysis determines a deviation in the water content of the wood chips from its ideal value, which is preferably 9.5-11%, the chips are moistened with hot water. The hot water is at a temperature of 98° C., which does not withdraw any heat from the shredded wood chips to be moistened. The heat stored in the wood chips is advantageously increased further.

An adequate water content has the advantage that a water film is formed between the wood chips and a conveyor chute for the wood chips, for example. Lubrication of conveyor lines can thus be ensured. Furthermore, the risk of fire can be reduced by an adequate water content.

A ripening tank 8 is arranged downstream from the first conditioner 7. In this tank, the wood fibers and/or the shredded wood chips are stored temporarily for a period of approx. 10-15 minutes and mixed thoroughly, so that the water can penetrate uniformly into the wood chips. Thus, after conditioning the fibers of the wood chips for uniform properties, the water can penetrate uniformly into the raw material and make the wood chips more uniform. Next, the fibers from the wood chips are conveyed to a second conditioner 9 by means of a discharge stirring mechanism (not shown).

In the second conditioner, which follows the ripening tank, the water content of the shredded wood chips and/or fibers from the wood chips is measured again and the chips are moistened with hot water again depending on the result. This process is carried out by means of ultrasonic measurement and is preferably adjusted by a pelletizing technician by hand. Based on the adjustment of the correct water content in the fibers of the wood chips it is also possible to activate the so-called lignin in the fibers of the raw material as an adhesive. In the second conditioner 9, which also has a measurement station for detecting the moisture content of the fibers from the wood chips as well as having a paddle mixer, the total wood chips are again checked for a uniform moisture content, which is then adjusted accordingly, if necessary.

After adjusting the parameters, in particular the moisture content for the fibers from the wood chips, the chips go a pellet press 10. The press 10 receives the fiber material from the outlet of the second conditioner 9, wherein the material is conveyed onto a die inside the press by means of a sliding device. Such a press is a so-called die press, in which ring dies and flat dies are used for pelletizing wood fibers. The shredded wood chips and/or the fibers from the wood chips are pressed by grinding rollers through boreholes and/or press channels in the die, where the cone angle at the start of the press channel is adapted to the respective pellets to be produced. The pressing takes place at a high pressure and at least 40° C. as well as a water content between 9.5 and 11%.

Because of the prevailing pressure conditions and the mechanical work induced by the grinding wheels as well as due to the friction on the fibers from the wood chips due to the die, a temperature higher than approx. 95° C. is reached in the wood chip fibers in the press channel. In this way the lignin contained in the raw material is released and activated. The lignin inside the press provides lubrication but also acts as an adhesive for the pellets. In this way, for example, a stable shape for the pellets can be obtained because the activated lignin acts as a stabilizer and thus ensures stable wood pellets after pressing.

At the outlet end of the die of the pellet press 10, the discharged pellets are then cut and/or broken to the desired length. The length of the pellets can be adjusted and altered through the adjustable cut length of the pellets and also through the diameter of the individual press channels of the die.

After pressing the pellets in the pellet press 10, they are at a temperature of approx. 103° C. At the outlet of the press 10, the pellets are picked up by a discharge conveyor belt and conveyed to the cooling apparatus embodied as a pellet countercurrent cooling 11 by means of a conveyor apparatus. The pellet countercurrent cooling 11 cools the pellets to ambient temperature with the help of outside air, so that a hardening of the pellets takes place at the same time. The exhaust air from the pellet countercurrent cooling 11 (approx. 80° C.) is sent through a heat dissipation channel 11a of a mixing apparatus in the form of a mixing box 5f wherein the heat stored in the exhaust air is carried from the heat dissipation channel 11athrough the mixing box 5f to the heat supply channel 3a of the dryer for the wood chips. The mixing box 5f can combine the heat stream from the pellet countercurrent cooling 11 with other heat streams in particular from other equipment. With the help of the mixing apparatus, consequently, the heat obtained by cooling the pellets can be combined and/or mixed with other heat streams from other equipment such as the exhaust heat from turbines or a turbine cooling and also transferred to the mixing apparatus.

After cooling the pellets, they enter a sorting apparatus for sorting the pellets, embodied as a double deck swinging sieve arrangement 12. This sieve arrangement is adapted to conform to a pellet standard such as EU standard ENplus A1 or ENplus A2 so that only pellets that conform to the standard can enter a downstream storage cell 13 for packaging, for example. The length of the pellets is too short, if the diameter is too small or if there is just dust, they are sent through a conveying screw in the direction of a heat recovery unit, embodied as a combustion unit 5a for combustion.

Before packaging the pellets in various sizes of bags or before filling the pellets into a silo truck and storing them in a storage cell, the cooled pellets are sieveed again to separate any fines of biomass and/or wood not bound within a pellet and send these back to the production process, i.e., the production stream, at the start at a wood chip dryer 3.

Furthermore, pellets whose length is outside of the standard are reduced to the correct length. This is preferably accomplished with the help of an adjustable breaking device such as a cracker at the end of a sieve deck. This device breaks the pellets to the standard length and conveys them further in the direction of the downstream storage cells 13. The storage cells 13 receive the pellets that have been produced and cooled to room temperature. The pellets can be loaded as loose material 14a, for example, from the storage cells 13 or can be bagged 14b in certain bag sizes. It is also possible to use the pellets thereby produced for gasification of pellets and for producing green power 14c.

The above discussion, summarized briefly in process steps, describes how, after drying wood chips in a rolling bed dryer of a wood chip dryer 3, the wood chips in particular the fibers such as wood fibers are sent to a first conditioner 7, where the shredded biomass and/or the shredded wood chips and/or the wood chip fibers are checked for their water content and adjusted to a water content between 9.5% and 11% if necessary.

Next the wood chip fibers are loaded into a ripening tank in which any hot water introduced in the first conditioner 7 is able to penetrate into the wood chip fibers uniformly.

A second conditioner 9, which again detects the water content of the shredded wood chips and/or the wood chip fibers and moistens them again with hot water, depending on the result, is installed after this. It is thus possible to prepare the so-called lignin in the wood chip fibers as an adhesive for activation.

Next the wood chip fibers are pressed to form pellets in a pellet press 10. Because of the mechanical work produced there as well as due to the friction of the wood chip fibers with a die of the press 10, the wood chips are heated to a temperature higher than approx. 95° C. The lignin contained in the raw material is released and activated in this way.

The pellets are cut to the desired length when they are discharged from the pellet press 10.

After producing the pellets, they are sent to a pellet countercurrent cooling 11. The pellet countercurrent cooling 11 cools the pellets to ambient temperature with the help of outside air, wherein the exhaust air from the pellet countercurrent cooling 11 (approx. 80° C.) is sent to a mixing box 5f. The mixing box 5f can combine the heat stream from the pellet countercurrent cooling 11 with other heat streams, in particular from other equipment such as ORCs and/or turbines. Thus the heat obtained by cooling the pellets can be combined and/or mixed with other heat streams.

After cooling the pellets, they are sieveed in accordance with a pellet standard such as EU standard ENplus A1 or ENplus A2 and then the pellets that conform to the standard are stored in a downstream storage cell 13. Pellets that do not conform to the standard are sent in the direction of a heat recovery unit, embodied as a combustion unit 5a for combustion and recovery of heat.

Next, the sieveed pellets are ready for sale and can be taken from the storage cell.

FIG. 3 shows a flow chart and a device for generating energy from biomass. The device comprises a heat recovery apparatus and as a combustion unit 5a for generating heat and a drying apparatus as a wood chip dryer 3.

Furthermore, the combustion unit 5a has a heat dissipation channel 5a-1, which is connected to a heat supply channel 3a of the wood chip dryer 3 to carry heat from the combustion unit 5a into the wood chip dryer 3.

The wood chip dryer 3 comprises a rolling bed dryer and optionally a die for further milling of the wood chips.

The die for milling may be a chipping machine, for example, which performs a milling of the wood chips in defined chip sizes by means of a gear constructed from rollers mounted with an offset, by means of a chipping drum or by means of an impact disk.

The rolling bed dryer has essentially a drum through which heat can flow and has paddle rollers which convey the milled wood chips through the drum from the entrance to the outlet.

Because of its functioning, the rolling bed dryer is suitable for bulk materials which require a long dwell time for drying because of the relatively high initial moisture content. The wood chips to be dried are kept in motion by means of the paddle roller rotating slowly in a bed with an oncoming flow of hot air from beneath, pushing and/or guiding the wood chips through the rolling bed dryer 3 and/or its drum. In doing so, the milled wood chips are kept constantly in circulation. This slow rotational movement of the paddle roller permits a good and thorough mixing of the wood chips in the drum and ensures that the water content of the wood chips will be reduced from approx. 40% to 9-10% before entering a discharge screw of the dryer. While the wood chips are in motion, hot drying air flows around them from above, preferably at a temperature of 90° C. to max. 105° C. The chips are therefore in contact with the drying air for a particularly long period of time, which leads to a uniform result.

The above-mentioned drying air and/or the heat stored in it is/are created in the combustion unit 5a, where the heat discharge channel 5a-1 of the combustion unit 5a is connected to the heat supply channel 3a of the wood chip dryer 3 to carry the heat, which is stored in air and is transferred with the help of the latter out of the combustion unit 5a and into the wood chip dryer 3.

For generating heat in the combustion unit 5a, combustible material and/or biomass preferably in the form of bark and dust and/or sawdust but also bark dust and non-solid wood constituents such as rotten portions of tree trunks are burned. This material is obtained from the wood chips which are dried in the rolling bed dryer of the wood chip dryer 3. This is preferably a biomass material, such as bark and dust, i.e., dust which cannot be processed further to wood pellets, for example. This material, such as non-fibrous constituents of biomass, e.g., sawdust, is advantageously separated in the rolling bed dryer. In addition, the separation of fibrous biomass material and non-fibrous constituents such as dust is possible in another sieve apparatus (not shown), which can be set up downstream from the wood chips 3 and/or the rolling bed dryer.

The non-fibrous biomass material such as dust, i.e., sawdust but also bark obtained in the sieve apparatus and/or in the rolling bed dryer is conveyed into the combustion unit 5a where the biomass material is burnt and thus converted to heat, wherein the ash content approx. 2% can be recycled to the surrounding agricultural and forest areas.

Due to the combustion of dried non-fibrous biomass material, which consists mostly of bark and bark dust with a water content of 5%, it is possible to ensure the production of dry combustion gases. In the present case, the combustion is so favorable that the plant does not require a flue during normal operation but instead an emergency flue (not shown) is provided.

After generating heat in the combustion unit 5a by burning non-fibrous biomass material such as bark as well as dust, this heat is sent to a mixer 5b, which mixes the heat generated in the combustion unit and stored in hot exhaust gas (approx. 90-1000° C.) of the combustion unit 5a, with outside air, so that after being mixed with the outside air, the heat is distributed to a larger mass flow at a temperature of approx. 530° C.

To remove contaminants such as solids and pollution from the mixture of hot exhaust gases and outside air, the mixture is sent to a MultiCyclone 5c as the separation apparatus connected to the mixer.

With the help of the MultiCyclone, the contamination that occurs due to burning sawdust, bark dust and non-solid wood constituents, for example, in the combustion unit 5a such as fine dust, for example, is/are filtered out. Thus approx. 300-400 mg dust per m³ is also conveyed from combustion in the combustion unit. The MultiCyclone 5c cleans the mixture by removing hot exhaust gases and outside air to approx. 100 mg dust per m³ [STP], where the separated fly ash is stored in ash containers. The MultiCyclone 5c does this by means of centrifugal force. This makes it easy to sort out fine dust or ash that is heavier than air. The cleaning and maintenance of such a filter are also less expensive in comparison with traditional types of filters. With the help of this embodiment, the mixture of exhaust gases and outside air can also be used for further processing.

The mixture from combustion is dry because of its 5% water content in the dry biomass in the wood chip dryer 3. Therefore, this opens up the possibility of carrying the mixture of hot exhaust gases and outside air through an ORC 5d and/or a plant in which waste heat is coupled to work.

In general terms, a plant in which waste heat is coupled to work and/or a plant according to the so-called organic Rankine cycle (abbreviated ORC) involves a method of operating steam turbines with a different process medium than steam, such as, for example, certain oils (e.g., silicone oil) with a low evaporation temperature. The method and the plant are used in particular when the available temperature gradient between the heat source and the heat sink is too low for operation of a steam-driven turbine.

Downstream from the MultiCyclone 5c, the mixture of hot exhaust gases and outside air from the combustion unit 5a is sent through three ORCs and/or ORC turbines 5d. The heat stream introduced with the mixture into the ORC turbines generates electricity or green power. It is of course also possible to use just one ORC or any number of ORCs.

In addition, the ORCs or other turbines also produce waste heat. The ORC turbines must also be cooled. The waste heat 5e-1 from the ORCs and the waste heat from turbine cooling 5e-2 of the ORCs are combined in a mixing apparatus in the form of a mixing box 5f.

The two water heat streams mentioned above are received in the turbine at approx. 530° C. on an exchange module (silicone oils) and the turbine can convert the difference in comparison with 260° into electricity. In other words, a temperature of approx. 260° is sent to the mixing box as waste heat. The turbine cooling 5e-2 has water circulation with a forward flow of 35° C. and a return flow of 55° C. This hot water is converted by means of a water-air exchanger (not shown) and sent to the mixing box 5f.

Other heat streams, for example, from a pellet countercurrent cooling or from other apparatuses can also be sent to the mixing box. Consequently, the heat obtained by cooling the ORCs can be mixed with other heat streams from other apparatuses such as, for example, exhaust heat from a pellet countercurrent cooling, and can also be sent to the mixing box and combined and/or mixed there with the help of mixing box 5f.

Different waste heat streams are combined in the mixing box 5f and mixed to a temperature of approx. 90° C. to 105° C. The heat collected in the mixing box 5f is transferred to air as the heat medium and discharged in the direction of the wood chip dryer 3.

Thus the heat generated in the combustion unit 5a, which is produced by burning dried non-fibrous biomass, such as dust, for example, but also bark from the wood chip dryer 3 can be transported into the wood chip dryer 3 for drying the non-fibrous biomass. This allows efficient utilization of biomass and heat with optimal protection of resources and the environment at the same time.

The device discussed above is suitable for carrying out a method in which heat is produced in a combustion unit 5a by burning non-fibrous biomass such as dust but also bark from a wood chip dryer 3.

Heat, which is stored in air, is produced by combustion. The air as a heating medium is mixed with further air in an air mixer 5b as the mixer, to thus distribute the heat to a larger mass stream and to reduce the temperature of the air coming from combustion unit on the whole.

Thus the mixed air is filtered by means of a MultiCyclone 5c to separate out the fine dust.

The cleaned hot air stream is sent to so-called ORCs, i.e., plants in which waste heat is coupled to work to generate electricity.

The waste heat produced by the ORCs as well as the waste heat from turbine cooling of the ORCs is sent to a mixing box 5f. Further heat streams, for example, from pellet countercurrent cooling, can also be sent to the mixing box. The heat collected in the mixing box 5f is sent in the direction of the wood chip dryer 3. Therefore the heat produced in the combustion unit 5a, generated by burning bark and dust, is transported via the heat dissipation channel 11a to the heat supply channel 3a into the wood chip dryer 3 for drying for further biomass.

FIG. 4 shows a production plant for wood pellets with a biomass processing device, a pelletizing device for producing wood pellets and a device for generating power from biomass.

To avoid repetition, reference is made to the descriptions above regarding FIGS. 1 through 3. Only the interfaces of the exemplary embodiments discussed in conjunction with the figures are described in relation to one another below.

As shown in FIG. 4, wood fibers from bark and sawdust and/or bark dust as well as non-solid wood constituents, such as rotten portions of tree trunks, are separated in the tumbler sieve 4, as shown in FIG. 4. In doing so, the wood chips on the order of magnitude or sawdust or bark that have been sorted out are sent to the combustion unit 5a for burning. The combustion unit burns the wood chips that have been sorted out and thereby produces heat. For the case of occurrence of low outside temperatures or poor dust material with a low energy content, it is also possible to utilize further material from the different sieve levels of the tumbler sieve for the combustion unit 5a.

After being converted into electricity, the heat generated in the combustion unit is sent to a mixing box 5f, where the heat stream is also sent to the pellet countercurrent cooling 11.

After bringing all the heat streams together and/or the heat streams of the combustion unit 5a and of the pellet countercurrent cooling 11, the collected heat is discharged to the wood chip dryer 3 to dry the wood chips and to predry the wood from forest thinnings on the sliding bottom.

In this way, the heat generated during pellet production is used to prepare and/or predry biomass with bark.

In other words and in summary, the heat generated is sent from the site of its production, the combustion unit, to the wood chip dryer 3 and then further to the sliding bottom 2. This is accomplished by using air as the heating medium. Thus, heat produced by burning and stored in air is collected without heat exchange losses in the individual apparatuses such as the combustion unit 5a, the ORC 5d and the pellet countercurrent cooling unit 11, and then is delivered to the biomass in the wood chip dryer 3 and on the sliding bottom 2.

### Modification

The following modification of the preceding exemplary embodiments is directed at the utilization of the material of the biomass whereas the preceding embodiments have been concerned essentially with the energetic utilization of biomass. In particular the following embodiment relates to the utilization of the material of wood fibers which is made possible in conjunction with the biomass processing device described above.

As described above, apparatuses are used in the biomass processing device to produce wood fibers from wood, for example. In the exemplary embodiment described above, the hammer mill 4 shown in FIG. 1 and the tumbler sieve 5 also shown in that figure are used for this purpose.

Therefore the goal of the present modification is to consider the substantive use of the wood fibers as a priority and to operate the energetic processing as a supplementary process. Specifically in this regard, the chips of material are used with bark, as described above, and are milled. The chopped material is conveyed on a sliding bottom and is introduced uniformly into a rolling bed dryer by means of the metering screw. Milling of the bark and separation of the bark in the total mixture are performed in this modification in the same way as that described in the preceding exemplary embodiments.

However, fiber material suitable for utilizing the material is taken from the tumbler sieve 5 illustrated in FIG. 1. To do so, the tumbler sieve 5 is designed in multiple stages so that the fiber characteristics can be controlled in a customer-specific manner in particular with regard to diameter and length. Furthermore, in this modification it is possible to produce clean sorted fibers to customer specification. In this way clean sorted wood is used at the entrance to the overall process. The mesh of the sieves of the tumbler sieve 5 is coordinated specifically for the types of wood used in this modified embodiment.

In particular, the mesh of the sieves is coordinated very narrowly and the rotational speed of the tumbler sieve machine is also adjusted to the quality of the fibers. The fibers that are not suitable for further processing as a substance are separated and conveyed into the preliminary container of pellet production, for example, which was already described in the preceding exemplary embodiment. The fibers that are made available from the process for utilizing the material may either be stored temporarily or sent directly to a processing device, which is connected to the biomass processing device, for utilization of the material of the fibers. The latter alternative is preferred because fine ground wood fibers with a very low moisture content of preferably no more than 1% are necessary for processing of the material, and storage would either have a negative effect on the quality of the fibers or the quality can be maintained during storage only at great expense.

Thus, the basic concept of the present modification is to use the biomass processing device, which is used in the exemplary embodiments described above and the respective process for providing fibers for utilizing the material as fibers. In this application, the starting material that is used is selected for utilizing the material as fibers with regard to the properties and quality of the fibers. The constituents that are not accessible to utilizing the material as fibers are used for energetic biomass utilization in the process described above.

It is particularly advantageous if the device for utilizing the material as fibers is connected to the biomass processing device. The device for utilizing the material of the fibers may comprise, for example, plastic production in which the wood fibers are used as a reinforcing material. In particular injection molding devices may be provided in conjunction with the device for utilizing the material as fibers, supplying the fibers from the biomass processing device directly or at any rate without any great transport distance or long-term intermediate storage to the process for producing plastic elements reinforced with wood fibers.

The products produced in this way may include, for example, soft fiberboards, wood tiles and further elements, for example, parts for the automotive industry. Furthermore, it is also possible to utilize the wood fibers as a raw material for other applications.

The dust content of the fibers thereby produced is preferably discharged through a discharge screw and conveyed into the receiving tank of the firebox presented in the preceding exemplary embodiment. Furthermore, it is possible to perform an ultrasound-based moisture measurement on the fibers thereby produced to measure the product-specific required moisture content of the fibers and adjust it, for example, by means of a feedback loop.

### LIST OF REFERENCE NUMERALS

1 Coarse chipping machine
2 Conveyor apparatus
2a Heat supply channel
3 Drying apparatus
3a Heat supply channel
3b Heat dissipation channel
4 Mill
5 Tumbler sieve
5a Combustion unit
5a-1 Heat withdrawal channel
5b Air mixer
5c MultiCyclone
5d ORCs
5e-1 Waste heat
5e-2 Turbine cooling
6 Fiber silo
7 First conditioner
8 Ripening tank
9 Second conditioner
10 Pellet press
11 Pellet countercurrent cooling
11a Heat dissipation channel
12 Pellet sieve
13 Storage cells
14a Loading loose material
14b Bagging
14c Pellet gasification

1. A biomass processing device in particular for wood from forest thinnings, comprising
a) a conveyor apparatus (2) and
b) a drying apparatus (3),
wherein a heat dissipation channel (3a) of the drying apparatus (3) is connected to a heat supply channel (2a) of the conveyor apparatus (2) to carry heat from the drying apparatus (3) into the conveyor apparatus (2).

2. The biomass processing device according to claim 1, characterized in that the drying apparatus (3) has a rolling bed dryer for uniform drying and thorough mixing as well as preferably a tool for milling of biomass, in particular wood from forest thinnings.

3. The biomass processing device according to claim 1 or 2, characterized in that the conveyor apparatus (2) has at least one heat-permeable region, in particular a base at which biomass is arranged.

4. The biomass processing device according to any one of the preceding claims, characterized in that the biomass processing apparatus also has a shredding apparatus (4) and/or a separation apparatus (5).

5. The biomass processing device according to claim 4, characterized in that the shredding apparatus (4) has a mill that shreds the biomass.

6. The biomass processing device according to any one of claim 4 or 5, characterized in that the separation apparatus (5) has at least a sieve, in particular a tumbler sieve for separation into at least two separation fractions, preferably for separation of wood fibers and sawdust.

7. The biomass processing device according to any one of claim 4 or 5, characterized in that the separation apparatus (5) has optical means for optical separation into at least two separation fractions, preferably for separation of wood fibers and sawdust.

8. The biomass processing device according to any one of claims 1 to 7, characterized in that the biomass processing apparatus has a buffer (6) which is preferably arranged on the separation apparatus (5).

9. The biomass processing device, in particular having a biomass processing device according to any one of claims 1 to 8, comprising the steps:
a. Predrying biomass in a conveyor apparatus (2),
b. Drying the biomass with the help of a drying apparatus (3),
c. Dissipating heat from the drying apparatus (3) to a heat-permeable region of the conveyor apparatus (2).

10. The biomass processing method according to claim 9, comprising the further steps:
d. Shredding the biomass by means of a shredding apparatus (4),
e. Separating the shredded biomass into at least two separation fractions (5), preferably into wood fibers and sawdust.

11. The biomass processing method according to claim 9 or 10, wherein a separation fraction is used to generate heat and/or electricity.

12. The biomass processing method according to any one of claims 9 to 11, wherein heat generated by burning a separation fraction, in particular sawdust, is sent to the drying apparatus (3).

13. The biomass processing method according to any one of claims 9 to 12, wherein heat generated by producing electricity is sent to the drying apparatus (3).

14. The biomass processing method according to any one of claims 9 to 13, wherein heat from the conveyor apparatus (2) is sent to the outside, in particular into the environment.

15. The biomass processing method according to any one of claims 9 to 13, wherein a separation fraction, in particular wood fibers, is/are stored in a buffer (6).

16. A pelletizing device, in particular for producing pellets from biomass comprising
a) a drying apparatus (3) for drying biomass, in particular fibrous biomass, preferably wood fibers and/or for milling of biomass,
b) a press apparatus (10) for pressing pellets and
c) a cooling apparatus (11) for cooling pellets,
wherein a heat dissipation channel (11a) of the cooling apparatus (11) is connected to a heat supply channel (3a) of the drying apparatus (3) to carry heat from the cooling apparatus (11) into the drying apparatus (3).

17. The pelletizing device according to claim 16, characterized in that the device has a first conditioner (7), which detects the water content of the biomass in particular by means of ultrasound and/or adjusts the water content of the biomass by means of water from a water dosing apparatus to a water content between 7% and 13%, preferably to a water content of 9.5-11%.

18. The pelletizing device according to claim 16 or 17, characterized in that the device has a ripening apparatus (8) in which the biomass is stored temporarily and mixed thoroughly.

19. The pelletizing device according to any one of the preceding claims 16 to 18, characterized in that the device has a second conditioner (9) which detects the water content of the biomass, in particular by means of ultrasound, and/or adjusts the water content of the biomass to a water content between 7% and 13%, preferably to a water content of 9.5-11%, by means of water from a second water dosing apparatus.

20. The pelletizing device according to any one of the preceding claims 16 to 19, characterized in that the device comprises a sorting apparatus (12) for sorting the pellets.

21. The pelletizing device according to any one of the preceding claims 16 to 20, characterized in that a mixing apparatus (5f) combines heat obtained by cooling the pellets with other heat streams, in particular from other equipment.

22. A method for producing pellets, preferably wood pellets, in particular using a pelletizing device according to any one of claims 16 to 21, comprising the following steps:
a) Drying biomass, in particular fibrous biomass, preferably wood fibers with the help of a drying apparatus (3),
b) Pressing the biomass to form pellets with the help of a press apparatus (10),
c) Cooling the pellets with a cooling apparatus (11),
d) Dissipating heat from the cooling apparatus (11) to the drying apparatus (3).

23. The method according to claim 22, wherein after drying, the water content of the biomass is determined in particular by means of ultrasound.

24. The method according to claim 23, wherein after determining the water content of the biomass, the water content is increased by means of water from a water dosing apparatus, in particular to a water content between 7% and 13%, preferably to a water content of 9.5-11%.

25. The method according to any one of the preceding claims 22 to 24, wherein the biomass is stored temporarily in a ripening apparatus (8) and is mixed thoroughly to make the water content of the biomass more uniform.

26. The method according to claim 25, wherein after making the biomass more uniform, the water content of the biomass is determined again, in particular by means of ultrasound, and wherein the water content is increased by means of water from an further water dosing apparatus, preferably after determination of the water content of the biomass, in particular to a water content between 7% and 13%, preferably to a water content of 9.5-11%.

27. The method according to any one of the preceding claims 22 to 26, wherein by pressing the biomass to form pellets with the help of the press apparatus (10), the biomass is heated to a predetermined temperature, preferably between 85 and 115° C., in particular between 98 and 104° C.

28. The method according to any one of the preceding claims 22 to 27, wherein heat is dissipated from the pressed pellets to cool the pellets to a predefined temperature, preferably room temperature.

29. The method according to any one of the preceding claims 22 to 28, wherein heat obtained by cooling the pellets is combined with other heat streams, in particular from further areas of the method.

30. The method according to any one of the preceding claims 22 to 29, wherein the pellets are sorted after cooling, in particular being sieved, preferably in a tumbler sieve or a vibrating sieve (12).

31. The method according to claim 30, wherein the pellets are stored after being sorted so that they can be loaded as loose material and/or can be bagged and/or can be gassed for producing green power.

32. A device for generating power from biomass using a heat recovery apparatus (5a) for generating heat and a drying apparatus (3), wherein a heat dissipation channel (5a-1) of the heat recovery apparatus (5a) is connected to a heat supply channel (3a) of the drying apparatus (3) to carry heat from the heat recovery apparatus (5a) into the drying apparatus (3).

33. The device according to claim 32, characterized in that a mixer (5b) mixes hot fluid from the heat recovery apparatus (5a) with cool fluid to lower the temperature of the hot fluid.

34. The device according to claim 32 or 33, characterized in that a separation apparatus (5c) frees the fluid from the mixer (5b) of contaminants, in particular with the help of centrifugal force.

35. The device according to any one of the preceding claims 32 to 34, characterized in that the device has at least one turbine (5d) to which heat is sent from the heat recovery apparatus (5a) or from the mixer (5b) for generating electricity.

36. The device according to any one of the preceding claims 32 to 35, characterized in that the mixing apparatus (5f) receives heat from at least one turbine (5d) and/or heat generated by cooling the at least one turbine (5d) and is preferably combined with other heat streams from other regions of the process in particular.

37. A method for producing energy from biomass, in particular from fibrous biomass, preferably from wood fibers, in particular with a device for producing energy from biomass according to any one of claims 32 to 36, comprising the following steps:
a) generating heat by burning milled biomass, in particular sawdust and
b) drying the biomass with the help of heat generated by burning.

38. The method according to claim 37, wherein the heat generated is also used to drive at least one turbine for generating electricity.

39. The method according to claim 37 or 38, wherein the heat produced is stored in a fluid and the temperature of the fluid is reduced by adding further fluid, preferably air.

40. The method according to claim 39, wherein a separation apparatus filters contaminants out of the fluid, in particular by means of centrifugal force.

41. The method according to any one of the preceding claims 37 to 40, wherein waste heat from the turbines and/or heat produced by cooling the turbines is dissipated and is preferably combined with other heat streams in particular from other regions of the process.

42. A device for utilizing the material of wood fibers, wherein the device is connected to a biomass processing device according to any one of claims 1-8, 16-21, 32-36 and the device has means for processing the fibers to yield an intermediate or end product.

43. The device according to claim 42, wherein the operation of the biomass processing device is set up so that fibers can be produced to meet predetermined specifications.

44. The device according to claim 42 or 43, wherein the utilization of the material of the fibers obtained from the biomass processing device, the production of a multicomponent element, for example, a plastic composite material element, is designed by using wood fibers as a reinforcing material.

45. The device according to any one of claims 42-44, wherein for utilizing the material of the fibers, an injection molding device is provided, equipped for producing fiber-reinforced plastic parts by using the fibers from the biomass processing device.

46. A method for utilizing the material of wood fibers, wherein the method according to any one of claims 9-15, 22-31, 37-41 is used to produce fibers that can be utilized substantively whereas material that cannot be utilized substantively is sent for energetic utilization.

47. The method according to claim 46, wherein the material is utilized by means of a process, which is coupled essentially directly to the process for producing the fibers by the method according to any one of claims 9-15, 22-31, 37-41.
